(19) United States
(12) Patent Application Publication
(10) Pub. No.: US 2008/0046546 A1
(43) Pub. Date: Feb. 21, 2008

(54) EFI based mechanism to export platform management capabilities to the OS

(76) Inventors: Pankaj N. Parmar, Portland, OR (US); Ajay Garg, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/506,960

(22) Filed: Aug. 18, 2006

(51) Int. Cl. G06F 15/177; H04L 12/66

(52) U.S. Cl. 709/220; 370/353

(57) ABSTRACT

In some embodiments of the present invention, an architecture comprises a cross platform specification for platform manageability to provide a secure execution environment independent of the host operating system which can execute third party management capability extensions, called Capability Modules (CM's) to enhance platform manageability. At least one embodiment of the present invention enables autonomic, utility, and on-demand computing. An operating system (OS) sensor effector transmits information about the health of the OS to the platform manageability (PM) component using EFI services. The PM component may enforce recovery actions to recover from disastrous conditions or recommend actions to host OS in order to prevent a possible fatal condition or a condition under which the OS could be subject to severe performance degradation. Other embodiments are described and claimed.

### FIELD OF THE INVENTION

An embodiment of the present invention relates generally to computing systems and, more specifically, to an architecture comprising a cross platform specification for platform manageability.

### BACKGROUND INFORMATION

Various mechanisms exist for managing a platform from an external source. Existing servers may utilize a baseboard management controller (BMC) processor to communicate information with a remote management system. Other methods may be currently under development to enable remote platform management for server, desktops, laptops, etc. Many manageability mechanisms require use of a host operating system (OS) on the platform to be managed.

### BRIEF DESCRIPTION OF THE DRAWINGS

The features and advantages of the present invention will become apparent from the following detailed description of the present invention in which:

FIG. 1 is a block diagram showing a platform on which embodiments of the invention may be implemented;

FIG. 2 is a block diagram illustrating an interface between platform manageability (PM) hardware and host OS, according to an embodiment of the invention;

FIG. 3 is a block diagram showing a traditional baseboard management controller (BMC) management stack as compared to an exemplary extensible firmware interface (EFI) runtime services based management stack, according to embodiments of the invention; and

FIG. 4 shows an exemplary structure for an EFI protocol for platform manageability to be implemented by an EFI compliant platform firmware (BIOS) and used by EFI compliant host OS, according to an embodiment of the invention.

### DETAILED DESCRIPTION

An embodiment of the present invention is a system and method relating to using a cross-platform management architecture providing a secure execution environment independent of the host operating system. In at least one embodiment, the present invention is intended to enable autonomic, utility, and on-demand computing.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

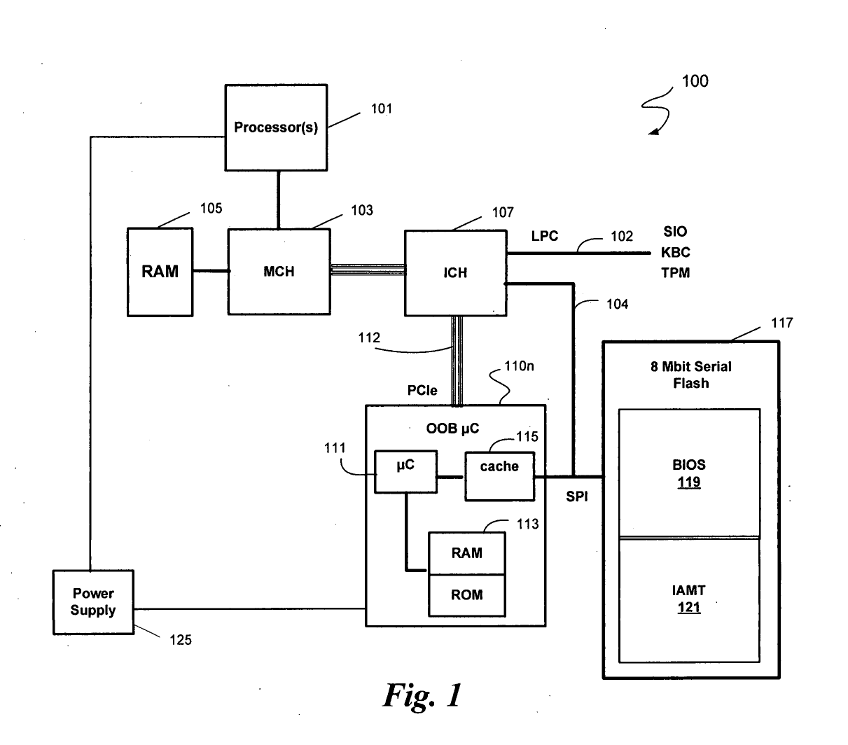

FIG. 1 is a block diagram illustrating features of a platform having a platform management microcontroller (PM μcontroller), according to an embodiment of the environment. A platform 100 comprises a host processor 101. The processor 101 may be connected to random access memory 105 via a memory controller hub 103. Processor 101 may be any type of processor capable of executing software, such as a microprocessor, digital signal processor, microcontroller, or the like. Though FIG. 1 shows only one such processor 101, there may be one or more processors in the platform 100 and one or more of the processors may include multiple threads, multiple cores, or the like.

The processor 101 may be further connected to I/O devices via an input/output controller hub (ICH) 107. The ICH may be coupled to various devices, such as a super I/O controller (SIO), keyboard controller (KBC), or trusted platform module (TPM) via a low pin count (LPC) bus 102. The SIO, for instance, may have access to floppy drives or industry standard architecture (ISA) devices. In an embodiment, the ICH is coupled to non-volatile memory via a serial peripheral interface (SPI) bus 104. The non-volatile memory may be flash memory or static random access memory (SRAM), or the like. A platform management μcontroller 110n may be present on the platform 100. The PM μcontroller 110n may connect to the ICH via a bus 112, typically a peripheral component interconnect (PCI) or PCI express bus. The PM μcontroller may also be coupled with the non-volatile memory store (NV store) 117 via the SPI bus 104. The NV store 117 may be flash memory or static RAM (SRAM), or the like. In many existing systems, the NV store is flash memory.

In embodiments, the PM μcontroller 110n may be likened to a “miniature” or an embedded processor. Like a full capability processor, the PM μcontroller has a processor unit 111 which may be operatively coupled to a cache memory 115, as well as RAM and ROM memory 113. The PM μcontroller may have a built-in network interface and independent connection to a power supply 125 to enable out-of-band communication even when the host processor 101 is not active.

In embodiments, the processor 101 has a basic input output system (BIOS) 119 in the NV store 117. In other embodiments, the processor 101 boots from a remote device (not shown) and the boot vector (pointer) resides in the BIOS portion 119 of the NV store 117. The PM μcontroller may have access to all of the contents of the NV store 117, including the BIOS portion 119 and a protected portion 121 of the non-volatile memory. In some embodiments, the protected portion 121 of memory may be secured with Intel® Active Management Technology (IAMT). The PM μcontroller may run an IAMT software stack. More information about IAMT may be found on the public Internet at URL www-intel-com/technology/manage/iamt/. (Note that periods have been replaced with dashes in URLs contained within this document in order to avoid inadvertent hyperlinks).

Since the BIOS portion of non-volatile memory may be modified by the OS or applications running within the OS, it can be vulnerable to malicious tampering. In embodiments, the protected area of memory 121, available only to the PM μcontroller, may be used to store critical boot vector and other information without risk of tampering. The only way to access the PM μcontroller side of the NV store 117 may be through verification via a proxy through the PM μcontroller, i.e., signature authentication or the like.

Many existing systems use the extensible firmware interface (EFI) based platform firmware and its associated flash variables. The EFI is a specification which defines a new model for the interface between operating systems and platform firmware, commonly known as Basic Input Output System (BIOS). The specification version 1.10, published Dec. 1, 2002, is available on the public Internet at URL developer-intel-com/technology/efi/main_specification.htm.

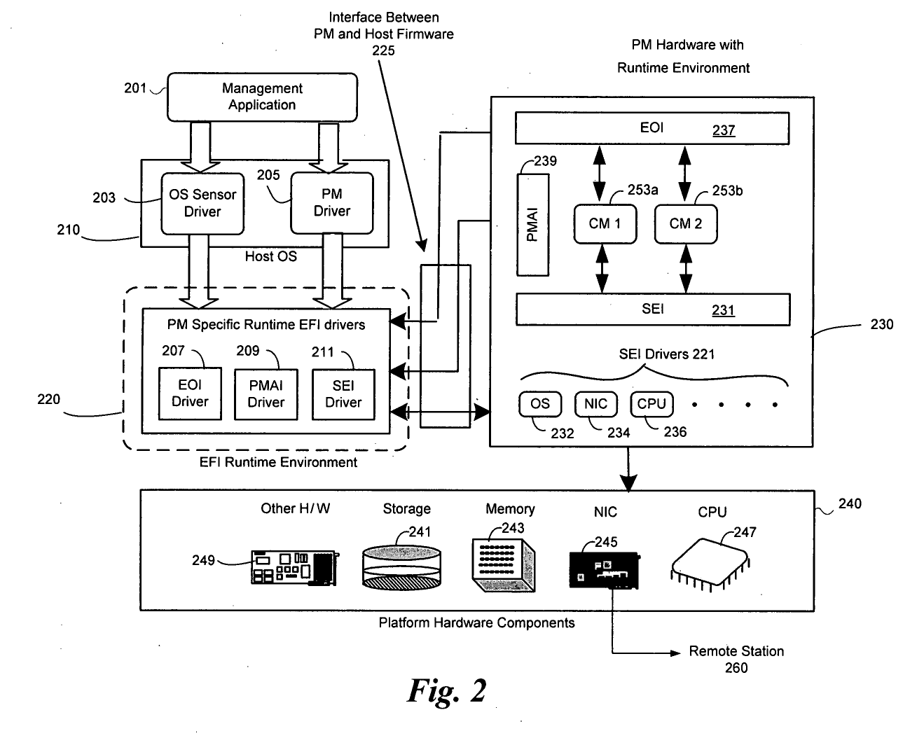

Embodiments of the present invention may utilize an architecture comprising a cross platform specification for platform manageability. Referring to FIG. 2, this architecture may enable an execution environment 230 independent of the host operating system 210 which can execute third party management capability extensions, called Capability Modules (CM's) 253. A CM 253 is a binary component that may be dynamically loaded over network and inserted into the runtime environment of PM 230. The CM 253 extends the manageability functionality provided by PM. A CM 253 relies on a set of services provided by the PM runtime environment 230 to operate and also uses different interfaces, for instance, SEI 231 to collect sensor data and take action. The PM runtime environment 230 exposes multiple interfaces such as Platform Manageability Administrative interface (PMAI) 239, Sensor Effector Interface (SEI) 231, (External Operations Interface) EOI 237. Each of these interfaces serves a unique purpose.

EOI 237 allows external entities to access and control the PM runtime environment 230 remotely. EOI 237 provides functionality such as discovery of platform capabilities, sensors, asset information, run diagnostic applications, provision the system, etc. PMAI 239 provides administrative functionality to regulate PM runtime environment 230. PMAI 239 allows actions such as querying/patching of drivers, OS, CMs, install/remove/star/stop of CMs, start/stop PM, etc. The SEI 231 defines functions which generically allows enumeration of devices on a system, read sensor data, write effector data etc. PMAI 239 and EOI 237 may be invoked remotely by an IT administrator. The architecture does not define any interface or mechanism to collaborate with the host operating system (OS) 210. A platform management solution running on desktops, servers or handhelds can offer more flexibility and control when co-operating with the OS. The interface between the PM and host OS 210 is shown as 225.

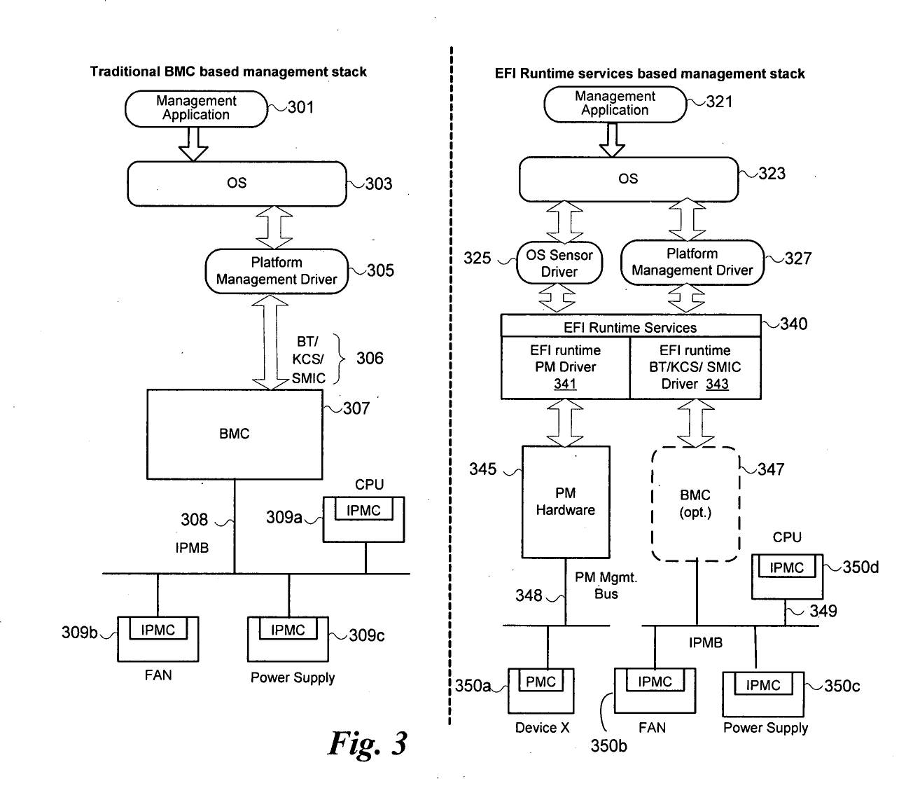

Embodiments of the present invention comprise a mechanism to allow a local management entity 205 running on the OS to communicate with the platform manageability component 230 and for the platform manageability component to monitor OS activity via Extensible Firmware Interface (EFI) runtime services 220 (207, 209, 211). In embodiments, the architecture utilizes “OS Sensors” 203 running in context of the OS 210 which allows the platform manageability infrastructure to monitor the OS health. The EFI runtime drivers 220 export an interface so that OS sensor information may be provided to the platform manageability infrastructure 230. The EFI runtime driver also exposes an interface so that the OS sensor driver may receive commands from an OS specific CM running in the context of PM runtime environment 230. By exposing the platform manageability interface to the OS, and allowing the platform manageability infrastructure to monitor OS activity and control OS recovery actions, embodiments of the present invention provide a versatile management solution that complements existing platform manageability architecture. Embodiments of the invention may be backward compatible with traditional BMC (Baseboard Management Controller) based platform management solutions, as discussed in conjunction with FIG. 3.

The platform manageability (PM) runtime 230 may be able to perform post-crash (OS) recovery based on information received from the OS sensor driver 203 up to the crash point. The runtime information may be collected by the OS sensor driver 203 and forwarded to the PM runtime 230 for processing. It will be apparent to one of ordinary skill in the art that various communication methods may be used. For instance, information may be passed via mailboxes, shared memory, or other communication methods. Recommendations may be sent back to the management application 201 or to a remote station 260 to effect changes in the system. Existing systems may check for version compatibility between the platform hardware/BIOS and platform OS/drivers. Embodiments of the present invention may also analyze the crash dump to perform more intelligent analysis. The PM may be able to forestall an OS crash, or provide recommendations to improve poor performance by monitoring OS performance data received from the OS sensor driver 203 through the SEI 211.

The EFI architecture defines a modular interface between the platform firmware (commonly known as BIOS) and the operating system (OS). An EFI compliant firmware implementation exports a data structure called the EFI system table to the OS and the OS loader. The OS must be EFI-aware to access the EFI system table which contains data (e.g. ACPI table) and a set of services (function pointers) know as the EFI runtime services. These services provide the OS with functionality such as retrieving/setting system time/date, querying/setting NVRAM variables etc. While these are just a handful set of standard services, EFI services are extensible to provide the OS with additional valuable functionality. Embodiments of the present invention extend the standard EFI runtime services to provide an interface to the platform manageability hardware in an OS-independent fashion and provide OS health information to the platform manageability infrastructure. EFI services may also be provided for traditional BMC (Baseboard Management Controller) based platform management hardware. Traditional BMC based platform management solutions are common on server platforms.

In an embodiment, embedded platform manageability component 230 comprises an ancillary processor or a microcontroller which co-exists with the host processor and may be integrated in the chipset or as a PCI device, as discussed in an exemplary embodiment in FIG. 1. The platform manageability processor may be a low cost, low power processor and may offer values such as providing low power always connected to the network while the main OS/processor is in sleep mode, or perform as an embedded platform to download remote third party management modules to perform platform management for example performing firewall capability via remote information technology (IT) management infrastructure.

Referring now to FIG. 3, on legacy server systems, a BMC chip 307 communicates with other devices over the IPMB (Intelligent Platform Management Bus) 308. The BMC 307 uses IPMI (Intelligent Platform Management Interface) as the standard message passing protocol. The BMC also exposes different interfaces like BT (Block Transfer), KCS (Keyboard Controller Style), SMIC (System Management Interface Chip) 306 by which the system management software components communicate. FIG. 2 shows the management stack.

Referring again to FIG. 2, in embodiments, a management application 201 running on the host processor communicates with the host operating system 210 via an operating system (OS) sensor driver 203 and a platform manageability (PM) driver 205. The host OS communicates with an extensible firmware interface (EFI) runtime environment 220. The EFI runtime environment 220 may comprise all interfaces that PM supports such as external operations interface (EOI) driver 207, a platform manageability administrative interface (PMAI) driver 209, and a sensor effector interface (SEI) driver 211. These interfaces, which may be optionally exposed to the host OS, may allow the host OS to take control of PM in absence of a remote management entity.

In FIG. 3, the OS sensor driver 325 may be configured to report all system parameters which impact OS performance, OS activity, software inventory etc. to the PM runtime environment 230 by periodically calling into EFI runtime services 340. The runtime analysis of OS health may be performed by a CM running in context of PM. The CM may also recommend actions to perform which can be communicated to the OS sensor driver via EFI interface. The OS sensor driver knows how to execute those actions. In contrast, BMC-centric management can only identify issues with things like thermal sensors and other hardware-based components.

Referring again to FIG. 2, the platform may have an ancillary processor coupled with a platform manageability hardware environment 230. This runtime environment 230 may have an external operations interface (EOI) 237, a sensor effector interface (SEI) 231, and PMAI 239 to correspond with the drivers 207, 209, 211 in the EFI runtime environment running on the host OS. The PM hardware and runtime environment 230 may also have a capability modules (CM) 235a-b. THE SEI 231 may comprise SEI drivers for the OS 232, network interface card (NIC) 234, and central processor unit (CPU) 236, etc. The SEI drivers 221 may communicate with platform hardware components 240, such as storage devices 241, memory devices 243, NICs 245, CPUs 247, or other hardware 249. In some embodiments, the PM may communicate to a remote management system 260 via a NIC 245. This NIC 245 may not be visible to the host OS 210 on the platform.

Referring again to FIG. 3, in a traditional BMC based platform, a management application 301 may communicate with the OS 303. A platform management driver 305 may communicate with the BMC 307 via a communication protocol 306 such as BT (Block Transfer), KCS (Keyboard Controller Style), or SMIC (System Management Interface Chip). The BMC 307 may communicate with various hardware devices (sensors) 309a-c via an IPMB 308. In existing systems, the BMC 307 may sense heat of the main processor, health of the power supply or speed of the processor. The BMC 307 typically communicates using IPMI protocol. Further, a BMC is typically only deployed with server systems.

In existing systems, a BMC 307 knows nothing about the health of the OS. For instance, BMC is unaware of an OS crash; the BMC is disconnected from the OS. In embodiments of platform manageability disclosed herein, the PM may be able to heal and repair OS problems. In contrast to traditional BMC-IPMI management, the PM has the ability to identify causes of an OS crash due to an extensible interface with the platform components. The PM driver 327 may have the ability to identify hardware driver problems and effect driver updates and then reboot the OS 323. Other updates may be effected, for instance, operating system (OS) patches, and BIOS updates. Traditional BMC management systems are strictly platform hardware management-centric. Embodiments of the PM system may query the OS to determine memory consumption, whether the system is running inefficiently, or whether a specific patch has been installed, i.e., a service pack. Embodiments may manage inventory of the platform, as well. The OS Sensor driver 325 communicates this information to the PM system through the PM specific EFI runtime drivers 340.

The OS sensor driver 325 may also provides the same information to a remote entity (i.e., 260 of FIG. 2) in case the system is managed by a remote administrator. The PM hardware and runtime environment may take control of the platform in conjunction with the remote management entity. For example, when the remote management entity loses network connection with the host, it may contact PM to take action in its behalf. If the PM fails to receive any notification from the remote entity, it may take over the platform control and attempt to heal the problem.

Platform management capability embedded in any platform, may be transparently exposed to the host OS as runtime EFI services, as can be seen in the right side of FIG. 3. In an EFI based platform manageability environment, according to embodiments of the invention, a management application 321 communicates with both an OS sensor driver 325 and a platform management driver 327 via the OS 323. EFI runtime services 340 may comprise an EFI PM driver 341 and an EFI BT/KCS/SMIC driver 343. As shown, the OS platform management driver will not use the KCS, BT kind of interface (see 306) to communicate with the BMC, but use a management application program interface (API) 343 exposed via EFI runtime services to control or query any manageable entity on the platform. The runtime services communicate with corresponding hardware, e.g. PM hardware 345 or a BMC 347. The PM hardware and BMC hardware may communicate with various hardware devices 350a-d via either a dedicated PM management bus 348 or an IPMB 349. The PM management bus does not change any of the EFI based runtime services. For instance, the PM hardware may communicate with a platform manageability controller 350a on a faster proprietary PM management bus 348 and the BMC may communicate with sensors on a CPU 350d, fan 350b, or power supply 350c via IPMB 349.

The API has no bearing on the underlying platform management hardware 345 or the interface it uses to communicate with other devices on the management bus. EFI runtimes services 340 may be implemented as runtime EFI drivers 341, 343 which are loaded by the EFI based firmware during pre-boot and persist in memory after post-boot. An EFI compliant OS can easily use these services. FIG. 3 shows different drivers for PM and BMC based platform management solutions. The BMC specific EFI driver 343 communicates with the BMC hardware 347 using one of the standard interfaces (BT, KCS or SMIC) and exposes functions to enumerate manageable devices, log events, retrieve Sensor Data Records (SDRs) etc. to the OS. Similarly, the PM runtime driver 341 communicates with the PM hardware 345 transparent to the OS, and exposes runtime functions which are compliant with different PM interface types such as EOI (237), PMAI (239) and SEI (231).

Referring again to FIG. 2, in embodiments, a sensor effector may control the speed of the main processor fan, and effect a change, if desired, for instance to reduce or increase the fan speed. SEI driver for the CPU 236, for instance, may be the actual SEI driver for the processor which contains the logic or code to control/monitor the sensors on the processor such as processor fan speed, processor temperature etc. SEI 231 is an interface, which could be implemented as a separate driver, that is generalized enough to work with all platform component specific drivers like 232, 234, 236. The management application 201 on the OS is the one that triggers the action (via an effector interface). Alternatively, a remote management application may connect directly to the PM hardware and take the same action or a CM running in the context of PM runtime environment can take an independent action via the effector interface for the OS sensor. The sensor effector information is communicated via the corresponding SEI driver 221. As discussed above, a capability module (CM 1) 253a may be controlled remotely via EOI 237. The CMs 253 are components that may provide autonomous functionality. For instance, the CMs 253 may read the sensor and take action via an effector interface. The CM is a local agent that may correct the problem independently. In the absence of a CM, the PM may allocate the fix to a remote application.

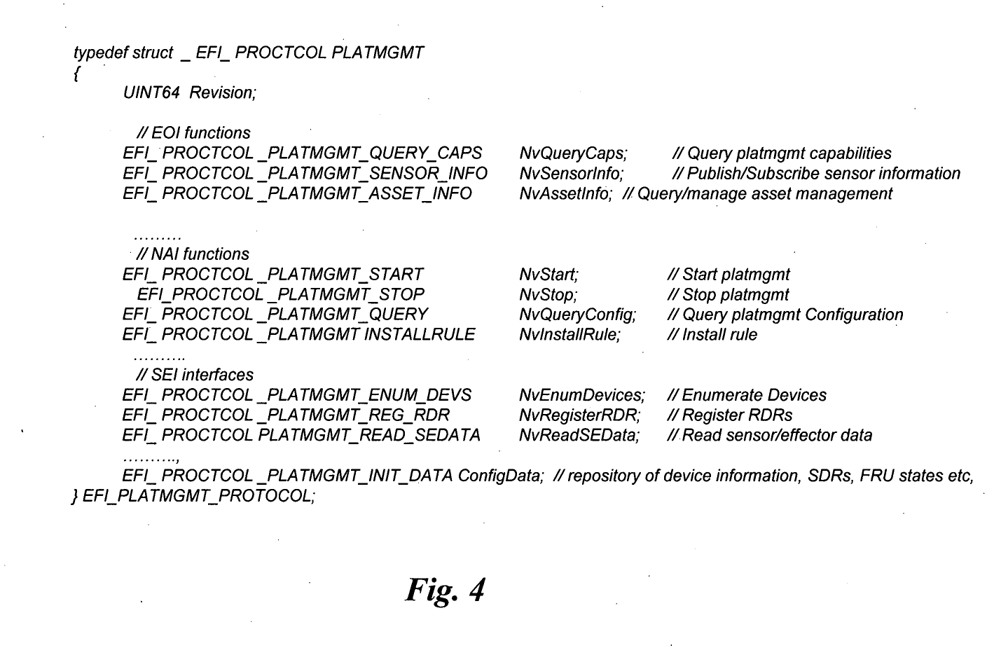

Referring now to FIG. 4, there is shown an exemplary structure for a protocol for platform manageability to be used on an EFI architecture. The EFI PLATMGMT protocol structure comprises several functions, or EFI services for the various EFI runtime drivers 207, 209, 211. For instance, the EOI driver 207 may implement functions for querying platform management capabilities (EFI_PROTOCOL_PLATMGMT_QUERY_CAPS), publishing and subscribing sensor information (EFI_PROTOCOL_PLATMGMT_SENSOR_INFO), and querying and managing assets on the platform (EFI_PROTOCOL_PLATMGMT_ASSET_INFO). The PMAI driver 209 may comprise functions for starting/stopping the platform manageability runtime (EFI_PROTOCOL_PLATMGMT_START and (EFI_PROTOCOL_PLATMGMT_STOP), querying the platform manageability configuration (EFI_PROTOCOL_PLATMGMT_QUERY), and installing rules (EFI_PROTOCOL_PLATMGMT_INSTALLRULE). The SEI driver 211 may comprise functions for enumerating devices (EFI_PROTOCOL_PLATMGMT_ENUMS_DEVS), registering the register data records (RDRs) which are the set of device registers mapped to memory (EFI_PROTOCOL_PLATMGMT_REG_RDR), reading sensor/effector data (EFI_PROTOCOL_PLATMGMT_READ_SEDATA), and defining a repository of device information, e.g., sensor data records (SDRs) describing sensors on a device, field replaceable unit (FRU) states, etc. (EFI_PROTOCOL_PLATMGMT_INIT_DATA).

The OS Sensor is a pseudo-sensor in the sense that it is not a physical sensor, but reads data related to OS performance, activity, software inventory etc. The SEI driver calls functions defined by SEI which are required to be implemented by every sensor driver including the OS sensor driver. It does not matter whether the sensor is physical or a pseudo-sensor. If the requested data is related to the OS, then the OS sensor driver returns the data to the EFI service in the same fashion as a physical sensor would.

The techniques described herein are not limited to any particular hardware or software configuration; they may find applicability in any computing, consumer electronics, or processing environment. The techniques may be implemented in hardware, software, or a combination of the two.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks or portions thereof may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A system for platform manageability comprising:
a host processor to run an extensible firmware interface (EFI) aware platform firmware (BIOS) and host operating system (OS), the host OS having an OS sensor driver to communicate health and performance related information of the host OS to a platform manageability component; and
the platform manageability (PM) component comprising a sensor effector interface (SEI) to enable a capability module (CM) to process the host OS health and performance related information, wherein the PM component operates independently of the OS.

2. The system as recited in claim 1, wherein the host OS has platform management-specific EFI runtime services to communicate to the PM hardware component.

3. The system as recited in claim 2, wherein a subset of functions comprising the platform management-specific EFI runtime services provide an interface to communicate with legacy BMC platform management hardware with limited changes to platform management components running on host OS.

4. The system as recited in claim 2, wherein the platform management-specific EFI runtime services implement an external operational interface (EOI) driver, a platform manageability administrative interface driver (PMAI) and a sensor effector interface (SEI), wherein the OS sensor driver provides host OS health and performance related information to the PM component via the SEI.

5. The system as recited in claim 1, wherein the CM is to monitor OS activity, collect OS performance data, determine the host OS health status and is to perform at least one of recommending an action to recover the OS from a fatal operating condition and effecting an action to recover the OS from a fatal operating condition.

6. The system as recited in claim 5, wherein an action comprises at least one of forcing a user to patch the operating system (OS), upgrading a BIOS, driver, changing system configuration parameters, and notifying a user of a recommendation to replace hardware.

7. The system as recited in claim 5, wherein recommending an action comprises notifying an end user to take an action to improvise system performance or protect the system from vulnerabilities.

8. The system as recited in claim 5, further comprising a baseboard management controller (BMC) to monitor the platform hardware.

9. The system as recited in claim 1, further comprising a network interface card (NIC) coupled to the PM component to communicate with a remote station.

10. The system as recited in claim 8, wherein the host OS has no visibility to the NIC coupled to the PM component.

11. A method for platform manageability comprising:
monitoring of a host operating system on a platform by an operating system sensor driver to determine OS health status and gather performance information of the operating system;
invoking an extensible firmware interface service to communicate the health status and performance information of the operating system to a platform manageability component; and
receiving the health and performance information of the operating system by the platform manageability component via a sensor effector interface, wherein the platform manageability component operates independently of the operating system.

12. The method as recited in claim 11, further comprising:
acting upon at least one of the health status and performance information by the platform manageability component.

13. The method as recited in claim 12, wherein acting comprises at least one of updating a software, hardware, or firmware component and fine tuning of performance configuration parameters of the host operating system; and
rebooting the platform.

14. The method as recited in claim 12, further comprising:
communicating with a remote station by the platform manageability component to determine an appropriate action to be taken based on the health status and performance information received.

15. A machine readable medium having instructions stored therein that when executed, cause the machine to:
monitor a host operating system on a platform by an operating system sensor driver to identify a health status and gather performance information of the operating system;
invoke an extensible firmware interface service to communicate the health status and performance information of the operating system to a platform manageability component; and
receive the health and performance information of the operating system by the platform manageability component via a sensor effector interface, wherein the platform manageability component operates independently of the operating system.

16. The medium as recited in claim 15, further comprising instructions that when executed, cause the machine to:
analyze the health status and performance information by the platform manageability component.

17. The medium as recited in claim 15, further comprising instructions that when executed, cause the machine to:
act upon the health status and performance information by performing at least one of updating a failed software component of the host OS, updating a failed firmware component of the host OS, and identifying problematic hardware; and
reboot the platform.

18. The medium as recited in claim 16, further comprising instructions that when executed cause the machine to:
communicate with a remote station by the platform manageability component, when a capability module is absent, to determine an appropriate action based on the health status and performance information received, before acting upon the health status and performance information; and when a capability module is present, determine an appropriate action by the capability module.
